(19) United States
(12) Patent Application Publication
(10) Pub. No.: US 2015/0130410 A1
(43) Pub. Date: May 14, 2015

(54) BATTERY PACKAGE AND ELECTRONIC DEVICE HAVING THE SAME

(71) Applicant: SAMSUNG ELECTRO-MECHANICS CO., LTD., Suwon-Si (KR)

(72) Inventors: Chang Mok HAN, Suwon-Si (KR); Ji Hoon Kim, Suwon-Si (KR); Sang Beom Lee, Suwon-Si (KR); Seung Won Park, Suwon-Si (KR); Hyung Wook Cho, Seung Won (KR); Ki Won Chang, Suwon-Si (KR); Jae Suk Sung, Suwon-si (KR); Sung Heum Park, Suwon-si (KR)

(73) Assignee: SAMSUNG ELECTRO-MECHANICS CO., LTD., Suwon-Si (KR)

(21) Appl. No.: 14/536,408

(22) Filed: Nov. 7, 2014

(30) Foreign Application Priority Data
Nov. 11, 2013 (KR) 10-2013-0136578
Jun. 3, 2014 (KR) 10-2014-0067384

(51) Int. Cl. H02J 7/02; H02J 7/00

(52) U.S. Cl. CPC H02J 7/025; H02J 7/0047
USPC 320/108

(57) ABSTRACT

There is provided an electronic device including a power-receiving unit configured to receive power by a contactless scheme, a battery package including a battery cell configured to be charged with the power received by the power-receiving unit, and an electronic device main body configured to receive the power from the battery package to perform a set operation.

### CROSS-REFERENCE TO RELATED APPLICATIONS

This application claims the benefit of Korean Patent Application Nos. 10-2013-0136578, filed on Nov. 11, 2013, and 10-2014-0067384, filed on Jun. 3, 2014, with the Korean Intellectual Property Office, the disclosures of which are incorporated in their entireties herein by reference.

### BACKGROUND

The present disclosure generally relates to a battery package for charging a battery cell and an electronic device having the same.

In order for an electronic device to receive power from its outside, an external power source may supply power to the electronic device. For portability, mobility, and the like of the electronic device, a battery package may be installed inside the electronic device and may receive power from a power source and supply the power to circuits comprised in the electronic device.

Power may be supplied to an electronic device by a contactless scheme. For example, a separate device, such as a cradle, may be used to hold an electronic device or a battery package so that power, which has been supplied from a power supply by a contactless scheme, is supplied to the battery package by a contact scheme. Alternatively, a separate power-receiving device installed in an electronic device can supply power, which is received from an external power supply by a contactless scheme, to a battery package by a contact scheme.

### RELATED ART DOCUMENT

### Patent Document

(Patent Document 1) Korean Patent Laid-Open Publication No. 10-2012-0136725

### SUMMARY

Some exemplary embodiments in the present disclosure may provide a battery package for receiving power by a contactless scheme and an electronic device having the same.

According to an exemplary embodiment in the present disclosure, an electronic device may include a battery package including a power-receiving unit receiving power by a contactless scheme and a battery cell charged with the power delivered from the power-receiving unit, and an electronic device main body receiving the power from the battery package to perform a set operation.

The battery package may further include a terminal unit through which voltage information of the battery cell and/or power status information related to a status of the power received by the power-receiving unit are input and/or output. The terminal unit may include a positive (+) voltage terminal and a negative (−) voltage terminal through which the voltage information of the battery cell is output, a power status information terminal through which the power status information is output, an NFC terminal electrically connected to an NFC antenna to input and output a communication signal, and a battery identification (ID) terminal through which electrical characteristics information is output.

The power status information terminal may share a ground with the negative (−) voltage terminal.

The power-receiving unit may include a power-receiving coil receiving power by the contactless scheme and a power-receiving circuit converting the power received by the power-receiving coil into charging power to charge the battery cell. The battery package may further include a near field communication (NFC) antenna performing near field communications.

The electronic device main body may further include a control unit receiving charging status information to control an operation of a charging control unit or receiving the power status information to control a charging status of the battery cell.

### BRIEF DESCRIPTION OF DRAWINGS

The above and other aspects, features and advantages in the present disclosure will be more clearly understood from the following detailed description taken in conjunction with the accompanying drawings, in which:

FIG. 1 is an exploded perspective view of an electronic device according to an exemplary embodiment in the present disclosure;

FIG. 2 is a schematic configuration diagram of a battery package according to an exemplary embodiment in the present disclosure;

FIG. 3 is a schematic block diagram of an electronic device and a battery package according to an exemplary embodiment in the present disclosure;

FIG. 4 is a diagram illustrating the configuration of a battery terminal unit according to an exemplary embodiment in the present disclosure;

FIG. 5 is a schematic block diagram of an electronic device and a battery package according to an exemplary embodiment in the present disclosure; and

FIG. 6 is a diagram illustrating the configuration of a battery terminal unit according to an exemplary embodiment in the present disclosure.

### DETAILED DESCRIPTION

Exemplary embodiments in the present disclosure will be described in detail with reference to the accompanying drawings so that those skilled in the art may easily practice the present disclosure.

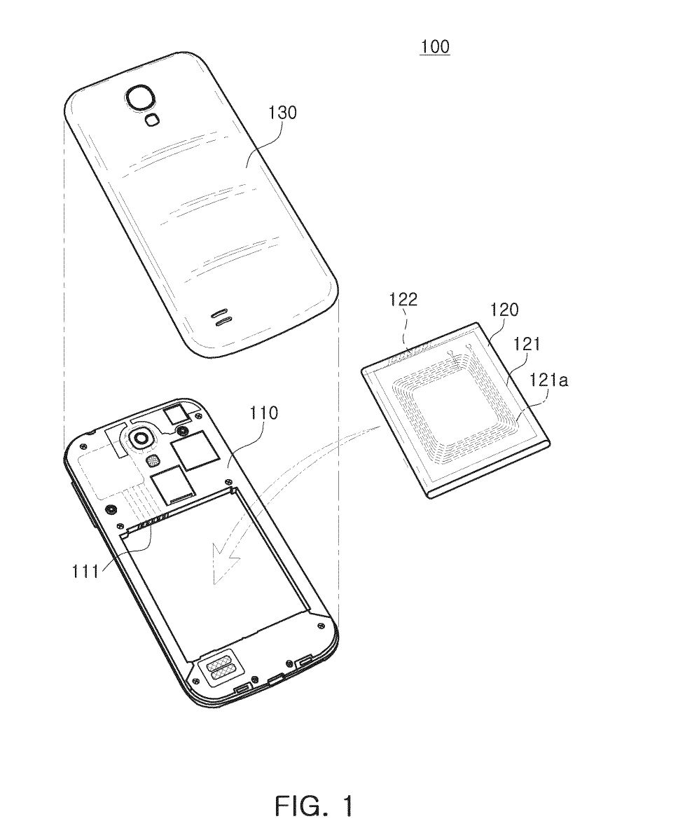

FIG. 1 is an exploded perspective view of an electronic device according to an exemplary embodiment in the present disclosure.

Referring to FIG. 1, an electronic device 100 according to an exemplary embodiment in the present disclosure may include an electronic device main body or an electronic device body 110 and a battery package 120. The battery package 120 may be installed in one area of the electronic device main body 110.

After the battery package 120 is disposed in a receiving area of a rear surface of the electronic device main body 110, an electronic device cover 130 may be coupled to the rear surface of the electronic device main body 110.

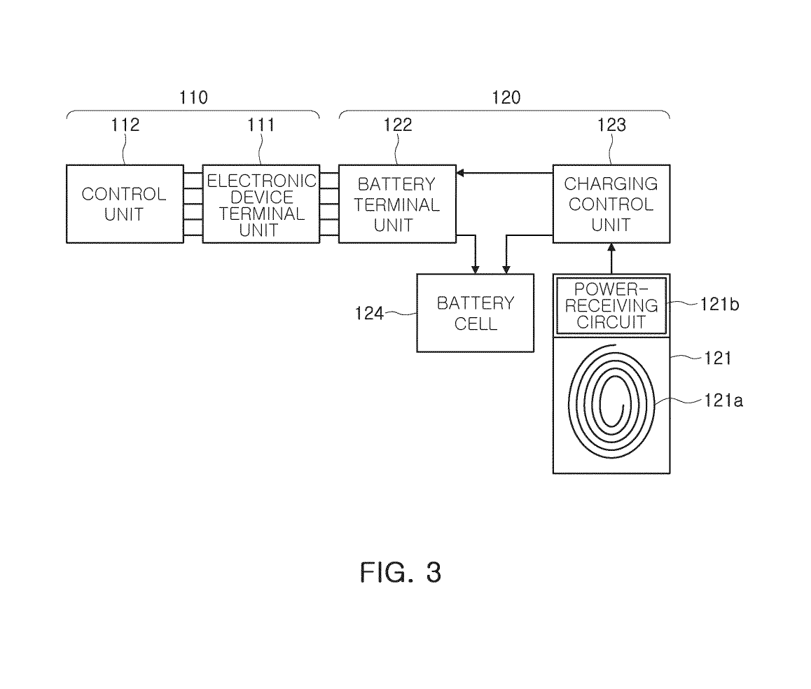

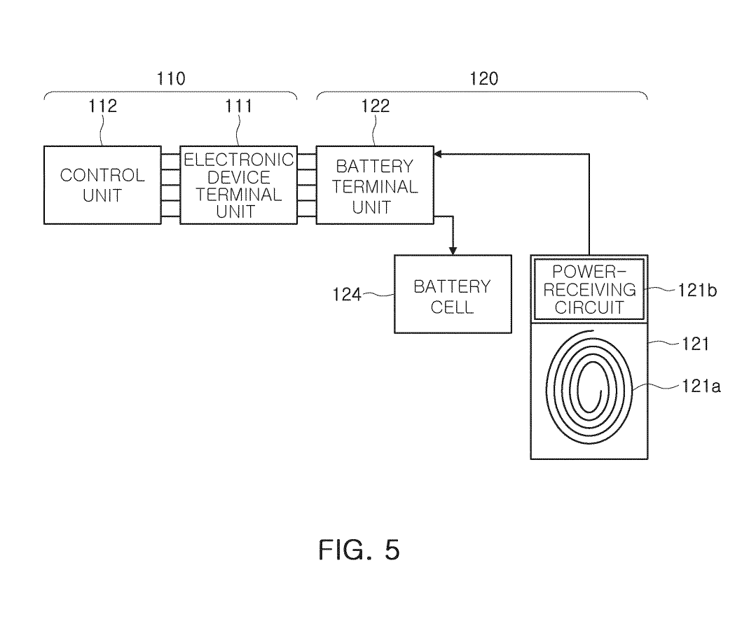

The battery package 120 may include a power-receiving unit 121 receiving power by a contactless scheme, and a terminal unit 122 (referred to as a battery terminal unit in FIGS. 3 and 5). The terminal unit 122 may transmit information to and/or receive information from the electronic device main body 110. The power-receiving unit 121 may include a power-receiving coil 121a.

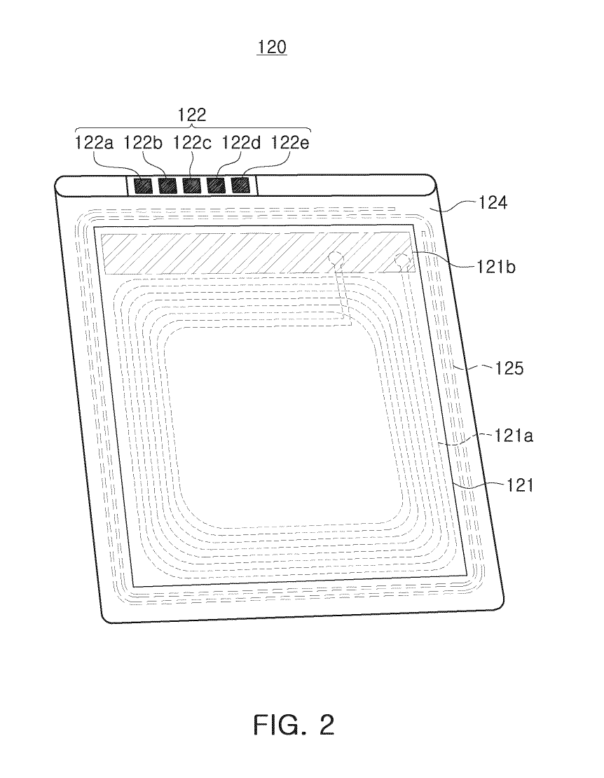

FIG. 2 is a schematic configuration diagram of a battery package according to an exemplary embodiment in the present disclosure.

Describing in more detail the battery package 120 illustrated in FIG. 1 with reference to FIG. 2, the battery package 120 according to an exemplary embodiment in the present disclosure may include the power-receiving unit 121, the terminal unit 122, a battery cell 124, and a near field communication (NFC) antenna 125.

The power-receiving unit 121 may include the power-receiving coil 121a receiving power by a contactless scheme, and a power-receiving circuit 121b appropriately converting the power received by the power-receiving coil 121a into power chargeable in the battery cell 124.

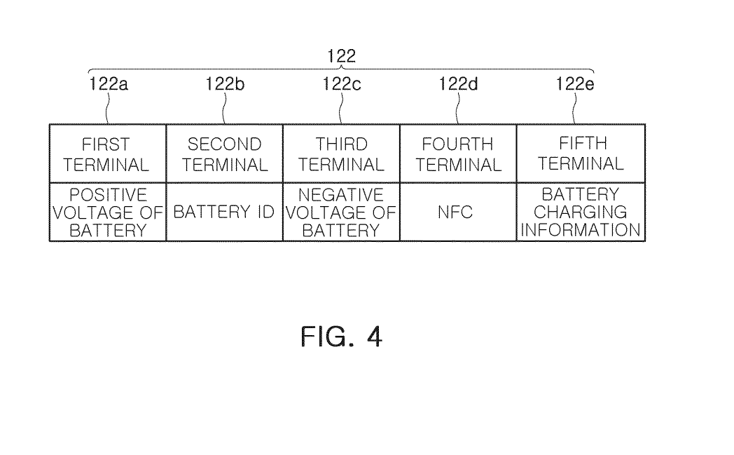

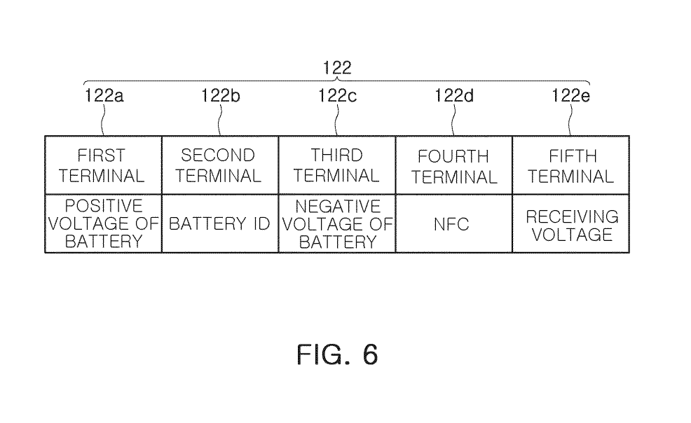

The terminal unit 122 may include a first terminal 122a, a second terminal 122b, a third terminal 122c, a fourth terminal 122d, and a fifth terminal 122e. The terminal unit 122 may be electrically connected to the power-receiving circuit 121b, the battery cell 124, the NFC antenna 125, and/or the like to transmit and/or receive information to and/or from the electronic device main body 110. This will be described in more detail with reference to FIGS. 4 and 6.

The battery cell 124 may be charged with the power from the power-receiving circuit 121b. The NFC antenna 125 may transmit and receive a preset signal to and from the outside of the electronic device 100 to perform near field communications. The NFC antenna 125 may be formed or disposed around the power-receiving coil 121a to minimize a volume of the battery package 120. The NFC antenna 125 may be formed around a circumference of the battery package 120.

For example, the NFC antenna 125 having the number of turns appropriate for the near field communications may be formed or disposed on one surface of the battery package and/or around the circumference of the battery package 120. The NFC antenna 125 may be provided with the power-receiving coil 121a having the number of turns appropriate to receive power from the outside of the electronic device 100 by the contactless scheme. For example, the power-receiving coil 121a may be disposed at the central area of the NFC antenna 125.

FIG. 3 is a schematic block diagram of an electronic device and a battery package according to an exemplary embodiment in the present disclosure, and FIG. 4 is a diagram illustrating the configuration of a terminal unit of a battery package according to an exemplary embodiment in the present disclosure.

Referring to FIG. 3, in the electronic device 100 and the battery package 120 according to this exemplary embodiment in the present disclosure, a control unit 112 of the electronic device main body 110 may transmit and/or receive information to and/or from the battery package 120 through an electronic device terminal unit 111.

The battery terminal unit 122 of the battery package 120 may be electrically connected to the electronic device terminal unit 111 of the electronic device main body 110 and may transmit and receive information therebetween.

Referring to FIGS. 3 and 4, the battery terminal unit 122 of the battery package 120 may include the first to fifth terminals 122a, 122b, 122c, 122d, and 122e. The first terminal 122a and the third terminal 122c may output voltage information of the battery cell 124.

For example, the first terminal 122a may be a positive (+) voltage terminal, and the third terminal 122c may be a negative (−) voltage terminal.

The second terminal 122b may output battery identification (ID) information. For instance, the second terminal 122b may be a battery ID terminal outputting electrical characteristics information of the battery package 120.

The electrical characteristics information of the battery package 120 may include, for example, but not limited to, battery capacity, appropriate or predetermined charging current, appropriate or predetermined charging voltage, and the like.

The fourth terminal 122d may be connected to the NFC antenna to transmit and/or receive information through near field communications. For example, the fourth terminal 122d may be an NFC terminal.

The fifth terminal 122e may output power status information related to the power received by the power-receiving unit 121. The power status information may be, for example, but not limited to, charging status information from a charging control unit 123.

In a case of inputting and outputting data, a positive (+) voltage terminal and a negative (−) voltage terminal may be needed. In inputting and outputting the power status information, the positive (+) voltage terminal may be the fifth terminal 122e and the negative (−) voltage terminal may be the third terminal 122c. The third terminal 122c may share a ground with the negative (−) voltage terminal.

As illustrated in FIG. 3, the battery package 120 may include the charging control unit 123. The charging control unit 123 may be electrically connected to the power-receiving circuit 121b of the power-receiving unit 121.

The power received by the power-receiving coil 121a may be converted into power appropriate to be charged in the battery cell 124 by the power-receiving circuit 121b. The charging control unit 123 may be connected between the power-receiving circuit 121b and the battery cell 124 and may adjust the power which is transmitted from the power-receiving circuit 121b to the battery cell 124, to control the power charging of the battery cell 124.

The control unit 112 may receive the charging status information from the charging control unit 123 to perform a set operation. For example, the control unit 112 may perform a control operation of displaying the charging status information on an output device such as a screen comprised in the electronic device main body 110.

FIG. 5 is a schematic block diagram of an electronic device and a battery package according to an exemplary embodiment in the present disclosure, and FIG. 6 is a diagram illustrating the configuration of a terminal unit of a battery package according to an exemplary embodiment in the present disclosure.

Referring to FIG. 5, in the electronic device 100 and the battery package 120 according to this exemplary embodiment in the present disclosure, the control unit 112 of the electronic device main body 110 may transmit and/or receive information to and/or from the battery package 120 through the electronic device terminal unit 111 of the electronic device main body 110. The battery terminal unit 122 of the battery package 120 may be electrically connected to the electronic device terminal unit 111 of the electronic device main body 110 to transmit and receive information.

Referring to FIGS. 5 and 6, the battery terminal unit 122 of the battery package 120 may include the first to fifth terminals 122a, 122b, 122c, 122d, and 122e. The first terminal 122a and the third terminal 122c may output voltage information of the battery cell 124.

For example, the first terminal 122a may be a positive (+) voltage terminal, and the third terminal 122c may be a negative (−) voltage terminal.

The second terminal 122b may output battery ID information. The second terminal 122b may be, for instance, but not limited to, a battery ID terminal outputting electrical characteristics information of the battery package 120.

The fourth terminal 122d may be connected to the NFC antenna to transmit and/or receive information through near field communications. For example, the fourth terminal 122d may be an NFC terminal.

The fifth terminal 122e may output power status information related to the power received by the power-receiving unit 121. The power status information may comprise, for instance, a voltage received by the power-receiving unit 121.

In a case of inputting and outputting data, a positive (+) voltage terminal and a negative (−) voltage terminal are required. In inputting and outputting the power status information, the positive (+) voltage terminal maybe the fifth terminal 122e, and the negative (−) voltage terminal may be the third terminal 122c. The third terminal 122c may share a ground with the negative (−) voltage terminal.

Unlike the embodiment illustrated in FIG. 3, in the electronic device and the battery package according to this exemplary embodiment in the present disclosure as illustrated in FIG. 5, the control unit 112 of the electronic device main body 110 may control charging power for of the battery cell 124.

The power received by the power-receiving coil 121a may be converted into power appropriate to be charged in the battery cell 124 by the power-receiving circuit 121b. The control unit 112 of the electronic device main body 110 may control charging power for the battery cell 124. The control unit 112 may adjust the power which is transmitted from the power-receiving circuit 121b to the battery cell 124, based on information related to the voltage charged in the battery cell 124 and/or information related to the voltage received by the power-receiving unit 121.

As set forth above, according to some exemplary embodiments in the present disclosure, the battery package 120 may include the power-receiving coil 121a, which may be independently charged with power by the contactless scheme. The electronic device main body 110 may monitor the power-charging status in real-time based on information related to the power-charging status or power-receiving voltage of the battery package 120 through a connection between the terminal units of the battery package 120 and the electronic device main body 110.

While exemplary embodiments have been shown and described above, it will be apparent to those skilled in the art that modifications and variations could be made without departing from the scope of the invention as defined by the appended claims.

What is claimed is:

1. A battery package, comprising:
a power receiving unit configured to contactlessly receive power; and
a battery cell configured to be charged with the power received by the power receiving unit.

2. The battery package of claim 1, further comprising a terminal unit configured to input and/or output voltage information of the battery cell and/or power status information related to a status of the power received by the power-receiving unit.

3. The battery package of claim 2, wherein the terminal unit includes:
a positive (+) voltage terminal and a negative (−) voltage terminal configured to output the voltage information of the battery cell; and
a status information terminal configured to output the power status information.

4. The battery package of claim 3, wherein the status information terminal shares a ground with the negative (−) voltage terminal.

5. The battery package of claim 3, further comprising a near field communication (NFC) antenna, wherein the terminal unit further includes an NFC terminal electrically connected to the NFC antenna to input and/or output a communication signal.

6. The battery package of claim 3, wherein the terminal unit further includes a battery identification (ID) terminal configured to output electrical characteristics information.

7. The battery package of claim 3, further comprising a charging control unit controlling a charging status of the battery cell, wherein the status information terminal outputs charging status information from the charging control unit.

8. The battery package of claim 3, wherein the status information terminal outputs the power status information related to the status of the power received by the power-receiving unit.

9. The battery package of claim 1, wherein the power-receiving unit includes:
a power-receiving coil configured to contactlessly receive the power; and
a power-receiving circuit configured to convert the power received by the power-receiving coil into charging power to charge the battery cell.

10. An electronic device, comprising:
a battery package including a power-receiving unit configured to contactlessly receive power and a battery cell configured to be charged with the power received by the power-receiving unit; and
an electronic device body configured to receive the power from the battery package.

11. The electronic device of claim 10, wherein:
the battery package further includes a battery terminal unit through which voltage information of the battery cell and/or power status information related to a status of the power received by the power-receiving unit are input to and/or output from the electronic device body, and
the electronic device body includes an electronic device terminal unit through which the voltage information and the power status information related to the status of the power received by the power-receiving unit are input to and/or output from the battery terminal unit.

12. The electronic device of claim 11, wherein the battery terminal unit includes:
a positive (+) voltage terminal and a negative (−) voltage terminal configured to output the voltage information of the battery cell; and
a status information terminal configured to output the power status information.

13. The electronic device of claim 12, wherein the status information terminal shares a ground with the negative (−) voltage terminal.

14. The electronic device of claim 12, wherein the battery package further includes a near field communication (NFC) antenna, and the battery terminal unit further includes an NFC terminal electrically connected to the NFC antenna to input and output a communication signal.

15. The electronic device of claim 12, wherein the battery terminal unit further includes a battery identification (ID) terminal configured to output electrical characteristics information of the battery package.

16. The electronic device of claim 12, wherein the battery package further includes a charging control unit controlling a charging status of the battery cell, and the status information terminal outputs charging status information from the charging control unit.

17. The electronic device of claim 16, wherein the electronic device body further includes a control unit receiving the charging status information to control a set operation.

18. The electronic device of claim 12, wherein the status information terminal outputs the power status information related to the status of the power received by the power-receiving unit.

19. The electronic device of claim 18, wherein the electronic device body further includes a control unit configured to receive the power status information and control a charging status of the battery cell.

20. The electronic device of claim 10, wherein the power-receiving unit includes:
a power-receiving coil configured to contactlessly receive the power; and
a power-receiving circuit converting the power received by the power-receiving coil into charging power to charge the battery cell.
